(19) United States
(12) Patent Application Publication
(10) Pub. No.: US 2018/0297828 A1
(43) Pub. Date: Oct. 18, 2018

(54) METHOD FOR FILLING A BOTTLE IN A FILLING LINE

(71) Applicants: Bernhard Orlich, Duesseldorf (DE); Stefan Strathmann, Erkrath (DE)

(72) Inventors: Bernhard Orlich, Duesseldorf (DE); Stefan Strathmann, Erkrath (DE)

(21) Appl. No.: 15/888,236

(22) Filed: Feb. 5, 2018

Related U.S. Application Data
(63) Continuation of application No. PCT/EP2016/067777, filed on Jul. 26, 2016.

(30) Foreign Application Priority Data
Aug. 6, 2015 (DE) 102015215043.7

(51) Int. Cl. B67B 3/00; B67C 7/00

(52) U.S. Cl. CPC B67B 3/00; B67C 7/00

(57) ABSTRACT

A method for filling a bottle in a filling line, with a product, preferably a washing or cleaning agent. Wherein, in a filling method step the product is filled into the bottle through a bottle neck. In a subsequent closing method step, a closure is put on the bottle neck, wherein before the closing a curable sealant in liquid or flowable form is applied to the bottle neck, in which the sealant is not yet fully cured at the time of closing.

### FIELD OF THE INVENTION

The invention relates to a method for filling a bottle line with a product, preferably with a washing or cleaning agent, the product being filled into the bottle through a bottle neck in a method step of filling and a cap being placed on the bottle neck in a subsequent method step of capping.

### BACKGROUND OF THE INVENTION

In order for it to be possible to dose washing agent in a reliable, rapid and precise manner, it is a desire on the part of the consumer for the bottle neck to have a sufficiently large diameter for the washing agent. This results in relatively high manufacturing tolerances. Gaps between the bottle neck and the cap, through which the liquid washing agent can escape to the outside, are almost inevitable. Furthermore, on account of the special components of the washing agent, such as surfactants, the surface tension of the washing agent is low, and therefore even the smallest of gaps lead to leaks. Therefore, a large proportion of bottles are not leakproof after the conventional, fully automated capping process in the bottling line.

When the washing agent bottle makes its way from the bottling line onto the market via the conventional distribution channels, it can generally be ensured that said washing agent bottle is kept in an upright position during transport and storage, and therefore a non-leakproof connection between the bottle neck and the cap does not have any negative consequences. This is not the case when the washing agent bottle is sold over the Internet and sent in a package directly to the consumer (e-commerce). The washing agent bottle may lie on one side or even upside down when being transported in the package, and therefore leaks between the bottle neck and the cap can lead to the washing agent running out before the package has reached the consumer. The saturated package and the no longer completely filled washing agent bottle are unacceptable to the consumer, and therefore the consumer is likely to complain. However, distribution via e-commerce will become ever more important, and therefore there is a need for well-sealed washing agent bottles.

It is known to insert a sealing ring into the cap in order to seal the connection between the bottle neck and the cap. However, this entails an additional method step during the production of the cap and thus results in higher costs. If the sealing ring is intended to be used only in caps for bottles which are to be sold by way of e-commerce, the bottling process becomes more complicated if said bottles are conveyed at the same time and along the same bottling line as bottles intended for conventional distribution.

It is also known to apply a sealing film onto the bottle neck. However, this requires major investment and leads to high ongoing part costs at lower line efficiency. Another possibility for improving the sealing between the bottle neck and the cap is to reduce the diameter of the bottle neck and thus the manufacturing tolerances. However, this is contrary to the wishes of the consumer.

### BRIEF SUMMARY OF THE INVENTION

The problem addressed by the invention is therefore that of providing a method for filling a bottle in a bottling line with a product, in particular for filling said bottle with a washing or cleaning agent, that can be carried out in a cost-effective manner and results in effective sealing of the connection between the cap and the bottle neck.

According to the invention, a curable sealant in liquid or flowable form is applied onto the bottle neck between the filling step and capping step, which sealant is not yet fully cured at the time of capping. When the cap is placed onto the bottle neck after the sealant has been applied, the sealant closes a possible gap between the bottle neck and the cap through which the product could otherwise escape to the outside when the cap is in place. The sealant can adhesively bond a surface of the bottle neck and a corresponding mating surface of the cap together, said adhesive bond having to be broken on first-time opening of the bottle. If the sealant is an adhesive sealant, capping occurs within the working window of the adhesive.

In one embodiment, the sealant is applied onto the bottle neck after the filling step but before the capping step.

Preferably, the sealant is a hot-melt adhesive which is applied onto the bottle neck in liquid state by means of corresponding temperature control. During cooling or after cooling, the sealant may be a plastic and/or resilient material. The sealant may also be a plastics material which foams during curing and can thus fill in the gap between the cap and the bottle neck. Preferably, the sealant consists of polyurethane adhesives or silicones.

The bottle neck may comprise an external thread onto which a cap comprising an internal thread is screwed. The cap or the bottle may be rotated about a longitudinal axis for the purpose of screwing. The method step of capping therefore comprises a screwing movement.

The sealant may be applied onto an end surface of the bottle neck. In the case of a round bottle neck, the end surface may be annular and form an upper rim of the bottle neck. Alternatively or additionally, the sealant may be applied onto a lateral surface of the bottle neck. In the embodiment comprising the external thread, the sealant may be applied onto the external thread. To this end, one turn, a plurality of turns or all turns of the external thread may be coated with the sealant. It is also possible for the sealant to be applied between the turns.

In one embodiment, the sealant is applied using an application roller. The application roller may in this case engage with an anilox roller, by means of which the application roller is wetted or dampened with the sealant. If a hot-melt adhesive is used as the sealant, the application roller is preferably a temperature-controlled application roller, i.e. a roller which is maintained at a temperature by means of heat input. The temperature of the application roller may for example be greater than 130 or even 150° C.

The sealant may be sprayed onto the bottle neck in the form of a bead. The application in the form of a bead can be combined with the application using the application roller. If a hot-melt adhesive is used for the spraying-on process, corresponding temperature control is also necessary here. Said temperature control can for example be achieved by means of a heated hot-melt adhesive cartridge and/or a heated spraying nozzle.

The period of time between the end of the filling step and the start of the capping step can be less than 5 or 2 seconds. This means that in the embodiment in which the sealant is not applied until after the filling step, there remains less than 5 or 2 seconds for the application. When using a hot-melt adhesive, the hot-melt adhesive is cooled and fully cured after the cap has been placed onto the bottle neck, or after the cap has been screwed onto the bottle neck.

The application weight of the sealant per bottle is preferably less than 0.5 g. In one embodiment of the invention, the application weight is 0.1 g and is therefore less than 0.2 g. The bottle may have a volume of from 0.5 to 5 liters.

### BRIEF DESCRIPTION OF THE DRAWINGS

The invention shall be described in further detail with reference to the drawings, in which:

FIG. 1 schematically shows individual method steps in a bottling line for filling a bottle; and

FIG. 2 is a longitudinal section through a bottle neck comprising an external thread.

### DETAILED DESCRIPTION OF THE INVENTION

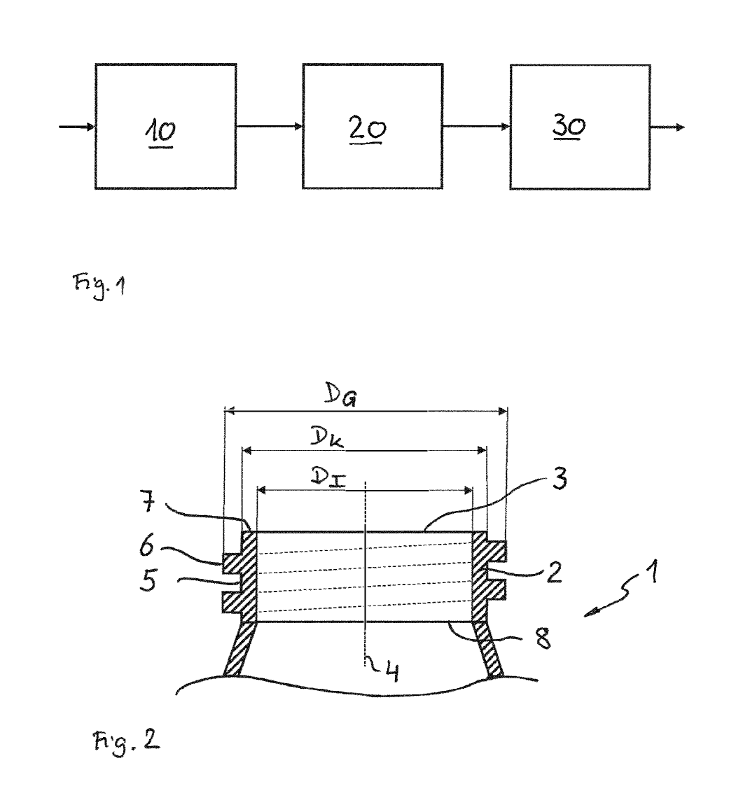

FIG. 1 schematically shows three successive method steps for filling a bottle in a bottling line with a product which may for example be a washing agent. In method step 10 the bottle is filled with the washing agent. Method step 10 of filling is to be considered completed when the bottle is completely filled in one embodiment, or filled with at least 80% of the desired amount of washing agent. Following method step 10 is method step 20, in which a sealant is applied onto the bottle neck. FIG. 2 shows an embodiment of the bottle neck, which is denoted by reference numeral 2 here. The method step 30 of capping follows method step 20. In this method step 30, a cap is placed onto the bottle neck. Placing the cap onto the bottle neck may involve a plurality of sub steps, such as screwing the cap onto the bottle neck. In the bottling line, all the method steps 10, 20 and 30 are carried out in a fully automated manner.

FIG. 2 is a longitudinal section through the upper portion of a bottle or washing agent bottle 1 that is known per se. The bottle 1 comprises the aforementioned bottle neck 2, which defines an opening 3 in the bottle 1. The bottle neck 2 is in this case substantially rotationally symmetrical with respect to a central axis 4. An external thread 6 is provided on a lateral surface 5 of the bottle neck 2, onto which external thread a cap (not shown) comprising an internal thread can be screwed.

The sealant may be applied onto the bottle neck at various points. For example, the sealant may be applied onto an annular end surface 7 of the bottle neck. An application roller may be used for this purpose, said roller passing over the entire end surface 7. In this way, the entire end surface 7 can be wetted. When the cap has been screwed on and is in a closed position, the end surface can rest against a corresponding mating surface of the cap. By means of the film of sealant on the end surface 7, the space between the end surface 7 and the mating surface can be completely sealed.

Alternatively or additionally, the sealant may be applied onto the lateral surface 5, for example onto the individual turns of the external thread 6 or onto the regions between the turns of the external thread 6. Preferably, the amount of sealant to be applied is kept small, preferably in the range of from 0.05 to 0.15 g.

The internal diameter Di of the bottle neck 2 may be from 10 to 100 mm. Preferably, the internal diameter Di ranges from 20 to 60 mm. The minor diameter DK may be from 2 to 10 mm (preferably from 3 to 8 mm) greater than the internal diameter Di. The thread diameter DG may be from 4 to 12 mm (preferably from 5 to 10 mm) greater than the internal diameter Di. The height of the bottle neck 2, which corresponds to the distance between the annular end surface 7 and a lower terminal edge 8, may be between 3 and 20 mm, preferably between 5 and 15 mm. In one embodiment, the internal diameter Di, the minor diameter DK, the thread diameter DG and the height of the bottle neck are 48.5 mm, 51.7 mm, 53.5 mm and 13.5 mm, respectively.

The capacity of the washing agent bottle (only shown in part) is intended to be from 1 to 5 liters.

### LIST OF REFERENCE SIGNS

1 bottle
2 bottle neck
3 opening
4 central axis
5 lateral surface
6 external thread
7 end surface
8 lower terminal edge
10 method step of filling
20 method step of applying sealant
30 method step of capping

What is claimed is:

1. A method for filling a bottle in a bottling line with a product, the product being filled into the bottle through a bottle neck in a method step of filling and a cap being placed onto the bottle neck in a subsequent method step of capping, comprising a step wherein a curable sealant in liquid or flowable form is applied onto the bottle neck before the capping step, wherein the curable sealant is not yet fully cured at the time of capping.

2. The method according to claim 1, wherein the curable sealant is applied between the filling step and the capping step.

3. The method according to claim 1, wherein the curable sealant is a hot-melt adhesive.

4. The method according to claim 1, wherein the bottle neck comprises an external thread onto which the cap comprising an internal thread is screwed.

5. The method according to claim 1, wherein the curable sealant is applied onto an end surface and/or a lateral surface of the bottle neck.

6. The method according to claim 1, wherein the curable sealant is applied using an application roller.

7. The method according to claim 1, wherein the curable sealant is sprayed on in the form of a bead.

8. The method according to claim 1, wherein the application weight of the curable sealant per bottle is less than 0.5 g.

9. The method according to claim 1, wherein the period of time between the end of the filling step and the start of the capping step is less than 2 seconds.

10. The method for filling a bottle in a bottling line according to claim 1, with a washing or cleaning agent, the product being filled into the bottle through a bottle neck in a method step of filling and a cap being placed onto the bottle neck in a subsequent method step of capping, wherein a curable sealant in liquid or flowable form is applied onto the bottle neck before the capping step, wherein the curable sealant is not yet fully cured at the time of capping.
